(19) United States
(12) Patent Application Publication
(10) Pub. No.: US 2003/0023461 A1
(43) Pub. Date: Jan. 30, 2003

(54) Internet based therapy management system

(76) Inventors: Dan Quintanilla, Irving, TX (US); C. Anthony Jones, Los Angeles, CA (US); Judith W. Reuter, Mundelein, IL (US); Brian Bertha, Valley Village, CA (US)

Correspondence Address: Wallenstein & Wagner, Ltd., 53rd Floor, 311 S. Wacker Drive, Chicago, IL, 60606-6630, US

(21) Appl. No.: 10/097,436

(22) Filed: Mar. 14, 2002

Related U.S. Application Data
(60) Provisional application No. 60/275,872, filed on Mar. 14, 2001.

(51) Int. Cl. G06F 17/60

(52) U.S. Cl. 705/3

(57) ABSTRACT

A system and method for managing patient health data is disclosed. The method comprising the steps of providing a plurality of input fields for receiving input data. The input data comprise at least one patient identifier, at least one patient criteria, at least one criteria condition, and at least one alert recipient. The method further comprises the steps of receiving a transmission of the at least one patient identifier, at least one patient criteria, at least one criteria condition corresponding to each of the at least one patient criteria and at least one alert recipient. The method further comprises the steps of receiving a transmission of health data, comparing the health data to the criteria condition, and transmitting an alert to alert recipients if the health data satisfies the criteria condition.

### RELATED APPLICATION

This claims the benefit of Provisional Patent Application Serial No. ______, filed Mar. 14, 2001, and is incorporated herein in its entirety by reference.

### TECHNICAL FIELD

This invention relates to systems and methods for managing patient health data. More particularly, the invention is directed to a communications network based system and method of managing the therapy of patients with chronic diseases such as hemophilia, diabetes or kidney disorders.

### BACKGROUND OF THE INVENTION

Managing chronic diseases such as hemophilia often requires frequent communication between a health provider and patient. Unfortunately, patients often fail to recall all of the relevant details of their medical history while visiting their health provider. Likewise, health providers often do not have time to visit patients frequently to sift through all of the information that their patients provide.

Patients also often fail to realize the need or urgency with which to alert their health providers to problematic circumstances. Communications between administrators is also frequently deficient, further reducing the effectiveness of a therapy program. In short, previous systems and methods for managing therapy suffer from a variety of problems and inefficiencies.

The present invention overcomes many of the problems and disadvantages of the prior therapy management systems by providing patients, care givers and administrators with online tools for effectively and efficiently managing needed therapy.

### SUMMARY OF THE INVENTION

The present invention relates to a system and method for managing patient health data. According to one aspect of the present invention, the method comprises the steps of providing a plurality of input fields for receiving input data. The input data comprises at least one patient identifier, at least one patient criteria, at least one criteria condition, and at least one alert recipient. The method further comprises the steps of receiving a transmission of the at least one patient identifier, at least one patient criteria, at least one criteria condition corresponding to each of the at least one patient criteria, and at least one alert recipient. The method further comprises the steps of receiving a transmission of health data, comparing the health data to the criteria condition, and transmitting an alert to alert recipients if the health data satisfies the criteria condition.

The present invention also relates to a computer program. Specifically, the computer program comprises a first code segment for receiving an input of patient selection data and second code segment for receiving a transmission input of at least one patient criteria and at least one criteria condition corresponding to said patient criteria. The program also comprises a third code segment for assigning the patient criteria and corresponding criteria condition to a patient, or group of patients. A fourth code segment receives a transmission input of an alert group. The program also has a fifth code segment for receiving a transmission of health data. The program also includes a sixth code segment for comparing the transmitted health data to the criteria condition, and to transmit a comparison result to a seventh code segment. The seventh code segment receives the comparison result and transmits an alert to the alert group if the comparison result correlates to the criteria condition.

The computer program may also have a code segment for defining a first user group in which the first user group is assigned a plurality of first user group access rights. One of the first user group access rights enables the first user group to create a user account for a second user group. The program also includes a second code segment for defining a second user group. Each member of the second user group is assigned an access identifier for the user account. The access identifier provides the second user group with a plurality of second user group access rights, and restricts the first user group from accessing certain account data associated with the user account.

These and other advantages will be made apparent from the following description of the drawings and detailed description of the invention.

### BRIEF DESCRIPTION OF THE DRAWINGS

FIG. 1 is a flowchart of the patient therapy management software according to the present invention;

FIG. 2 is a flowchart of the patient therapy management software according to the present invention;

FIG. 3 is a flowchart of the patient therapy management software according to the present invention;

FIG. 4 is an illustration of a patient entry record interface screen of the computer program of the present invention;

FIG. 5 is an illustration of an alternative embodiment of a patient entry record interface screen of the computer program of the present invention;

FIG. 6 is an alert list interface screen displayed on the health provider section of the computer program of the present invention;

FIG. 7 is a treatment log interface screen displayed on the health provider section of the computer program of the present invention;

FIGS. 8A-8C are illustrations of multiple alert center interface screens on the health provider side of the computer program of the present invention;

FIG. 9 is an illustration of a printable log record interface screen of the computer program of the present invention;

FIG. 10 is administrator welcome interface screen of the computer program of the present invention;

FIG. 11 is a flowchart illustrating a method for using the software of the present invention;

FIG. 12 is a structural diagram of an embodiment of the software of the present invention; and,

FIGS. 13-19 are illustrations of a various interface screens depicting reports that may be generated using the computer program of the present invention.

### DETAILED DESCRIPTION

While this invention is susceptible of embodiments in many different forms, there are shown in the drawings and will herein be described in detail, preferred embodiments of the invention with the understanding that the present disclosures are to be considered as exemplifications of the principles of the invention and are not intended to limit the broad aspects of the invention to the embodiments illustrated.

The invention generally relates to a computer program 1 (i.e., software application) provided through a network interface, typically an Internet website, that functions as a therapy platform. The website provides services to both patients (including the care givers of those patients) and their health providers (e.g., physicians and nurses). The computer program 1 is preferably configured to support the management of therapy for chronic diseases, such as hemophilia, diabetes or kidney disorders. More particularly, the computer program 1 of the present invention offers several benefits over prior systems, including: improved patient self-management, improved patient therapy compliance and a health provider's ability to remotely manage patients.

In one embodiment of the present invention, the invention may be implemented with the use of a microprocessor based server computer, commonly referred to as a host, which is connected to the Internet through standard communication hardware and software. This embodiment of the invention also can utilize a client computer such as a Microsoft Windows® based desktop or laptop computer system, a personal digital assistant or other electronic device having a standard web browser interface therein. The patient and the health provider utilizes the invention through such web-based electronic devices.

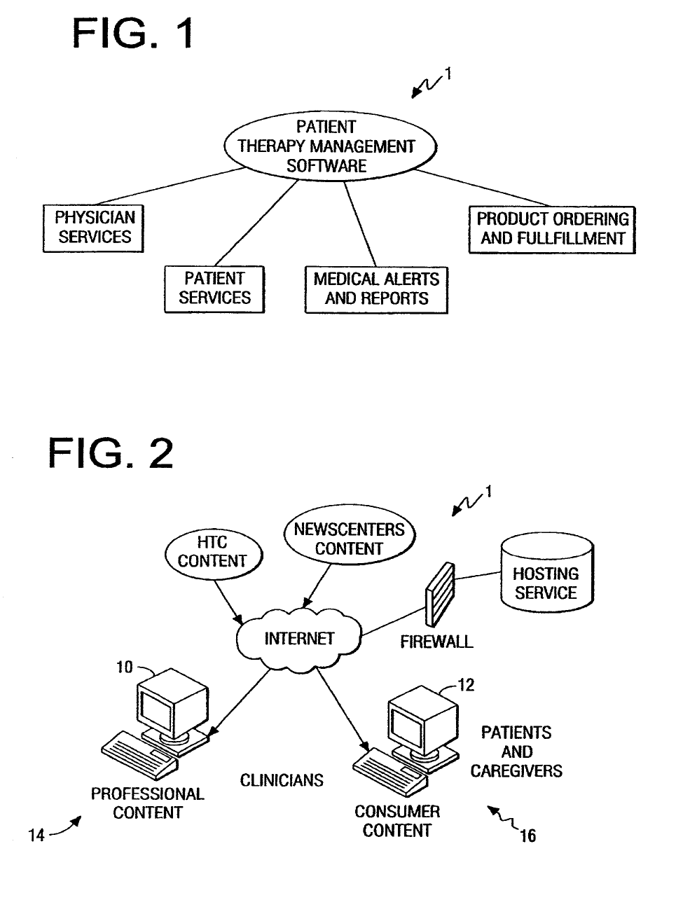

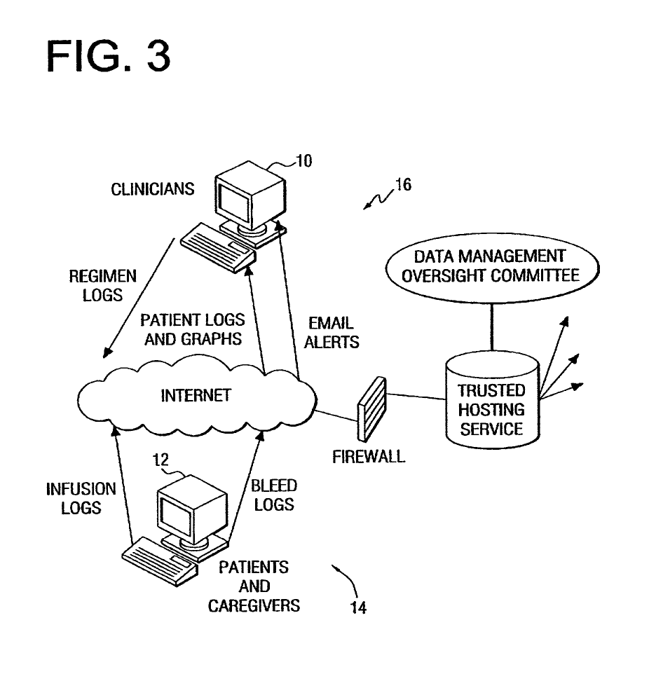

As illustrated in FIGS. 1-3, the computer program 1 establishes distinct sections of the website for patients and care givers on one hand, and the physicians, clinicians and/or healthcare providers on the other 14, 16. While visiting the patient section 16 of the website, patients or their care givers enter details about the conditions that the patient has experienced. For example, hemophilia patients can enter details concerning bleeds the patients have experienced, and infusions that they have received. The invention, however, should not be limited to use with patients experience symptoms of hemophilia. Instead, it is contemplated by the present invention that the patient could enter details about any conditions having workable conditions that a visually perceptible by a patient, tactilely perceptible by a patient or can be monitored by a patient or care giver. For example, the current invention can be used to monitor glucose monitoring, immune deficiency indicators, chemotherapy treatments, side effects of treatments, rashes or symptoms of any other major events caused by an illness or treatment regimen.

At the patient section 16, a patient may also review: historical logs of patient information; regimen logs provided by their health care providers that remind them of what medicines to take and when; and educational material. At the patient section 16, a patient may also participate in on-line activities focused on the hemophilia community from the patient section of the website, including community “chat rooms”.

Health providers, on the other hand, may visit a health provider section 14 of the website. While visiting the health provider section 14, health providers may review specific patient data, such as the bleed and infusion logs. Using such information, in conjunction with prior health information and patient interaction, health providers may make therapy recommendations to the patients via the computer program 1 between the health provider section 14 and the patient section 16 of the website. For example, a health provider can make a therapy recommendation concerning a patients' bleed log record or treatment regimen. Additionally, educational resources and appropriate on-line community activities may be made available to the health providers via the health provider section 14 of the website.

In one embodiment, the computer program 1 provides e-mail medical alerts when pre-determined conditions are met. For example, the health provider may enter modifiable medical thresholds or criteria conditions for each of his patients. When the data entered by a patient exceeds the entered threshold, or satisfies a prescribed criteria condition, an e-mail alert is sent to the health provider. The computer program 1 for managing patient health data is described more fully hereinafter.

In particular, the computer program 1 comprises a series of software code segments. More particularly, the computer program 1 comprises a first code segment. The first code segment receives an input of patient selection data. The patient selection data is defined by at least one patient identifier. For example, the patient identifier may be one or more patient names, patient identification numbers or groupings of patients having a similar condition. It is contemplated that the patient identifiers be any indicia commonly used by healthcare providers, or others who use this invention, to identify patients or patient care givers.

The computer program 1 also includes a second code segment for receiving a transmission input of at least one patient criteria, and at least one criteria condition corresponding to the patient criteria. A third code segment assigns the patient criteria and corresponding criteria condition to the patients that a user has identified as being part of the patient selection data. A fourth code segment receives a transmission input of an alert group. The alert group is defined by at least one alert recipient. Accordingly, the alert group may be a single health provider or a group of health providers. By way of example, the computer program may be set such that an alert recipient receives an e-mail alert if a patient does not report a bleed over a two week time interval.

According to the present invention, the computer program 1 also has a fifth code segment for receiving a transmission of health data. Typically, the health data is transmitted to a central server from a client machine. As discussed above, the health data corresponds to at least one of the patients comprising the patient selection data. The health data also corresponds to the assigned patient criteria correlating to the patient selection data. For example, the health data can be bleeds or infusion treatments. A sixth code segment compares the transmitted health data to the criteria condition and transmits a comparison result to a seventh code segment. The seventh code segment receives the comparison result from the sixth code segment, and transmits an alert to the defined alert group if the comparison result correlates to the criteria condition.

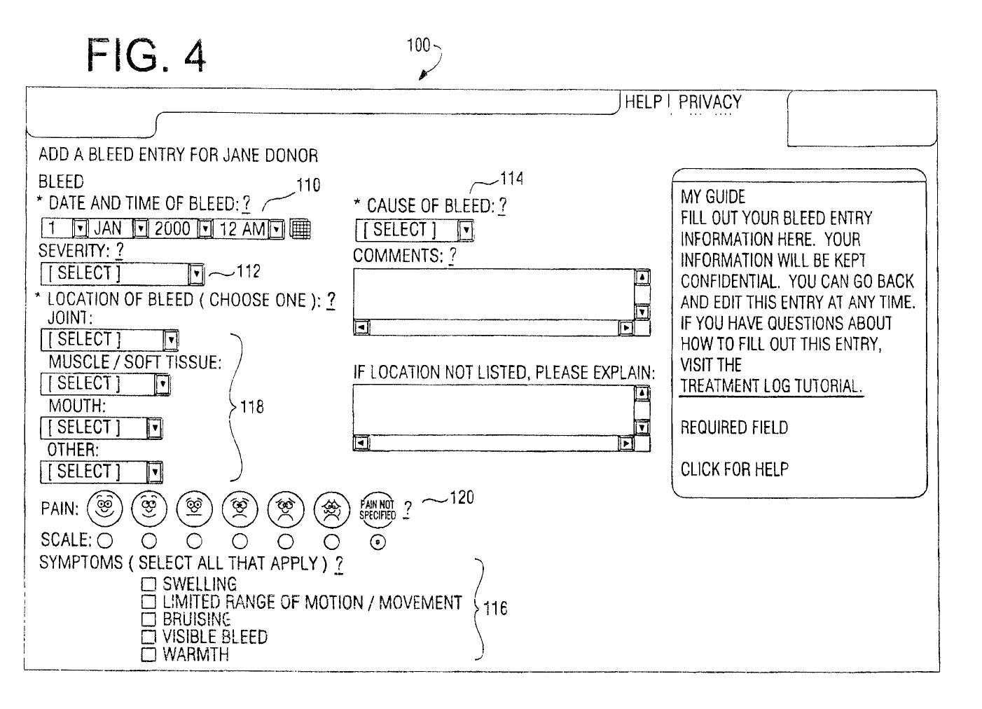

FIG. 4 depicts one embodiment of a patient entry record interface screen 100 that may be displayed on the patient section 16 of the present invention. The patient entry record 100 is adapted to allow a patient to enter health data corresponding to particular health criteria established by the health provider. In the embodiment illustrated in FIG. 4, the patient entry record 100 allows a patient to enter health data corresponding to hemophilia treatment (i.e., bleed entries). In particular, the entry record 100 allows a patient or a patient's care giver to enter the date and time of a bleed, the severity of a bleed and the location of a bleed in respective entry fields 110, 112, 118 of the entry record 100. The entry record 100 also allows a patient or care giver to select from a list of predetermined symptoms 116 that may be associated with the health data being monitored.

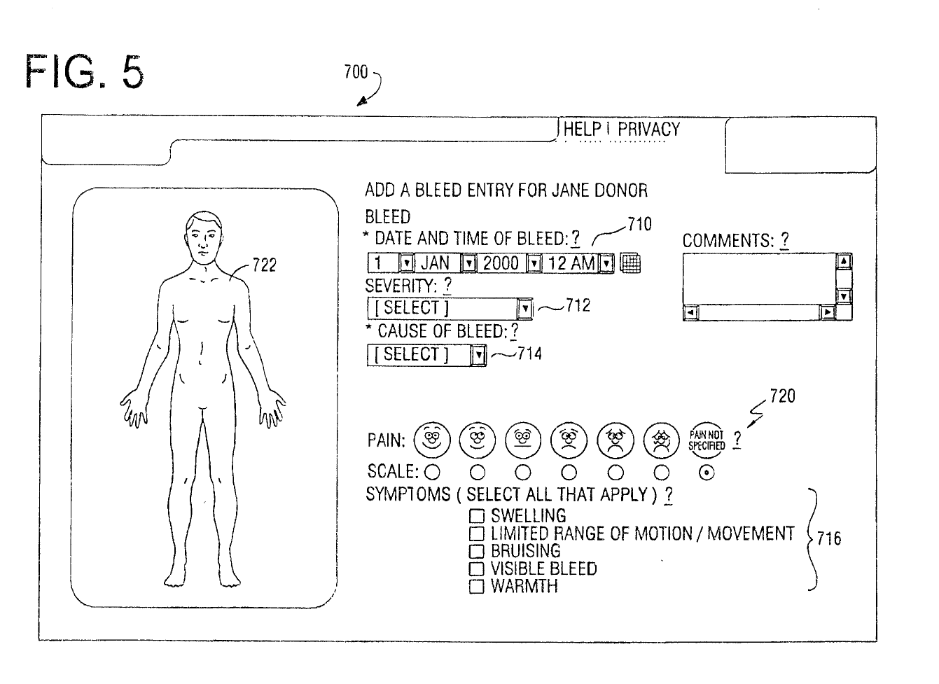

Alternatively, as shown in FIG. 5, the computer program may include a code segment for generating a graphical representation of a human body 722. The graphical representation of the human body 722 may be displayed on a client machine 12. According to this embodiment, the code segment for generating the graphical representation 722 also has a sensing system for sensing if a portion of the image 722 is selected by a user at the client machine 12. If a portion of the image 722 is selected, the code segment transmits health data corresponding to the selected portion of the image 722 to a host machine 10, server and/or a memory. For example, this image 722 may be used by a patient to designate the part of his body that has bled (e.g., an arm, leg, neck, nose, etc.) This health data may be displayed to a health provider or stored in a database, typically a relational database responsive to SQL queries, and may be subsequently used to search for matching data. The image 722 may also be used as part of an analytical tool to control further choices that are proposed to the user. For example, after selecting a body party on the image 722, a list of further selections may appear as a function of the body part that was previously selected.

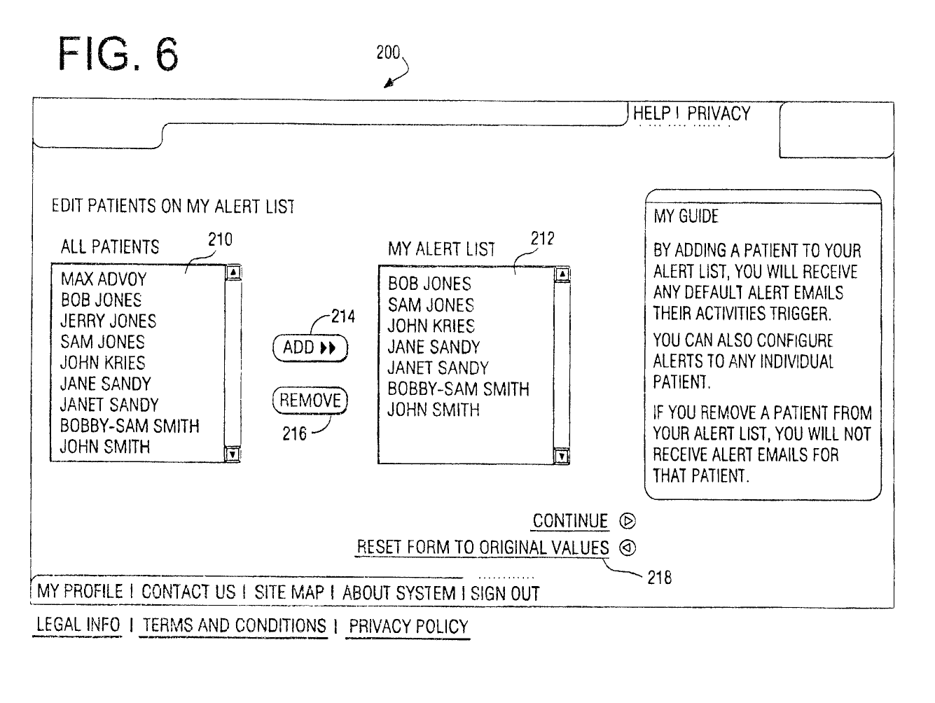

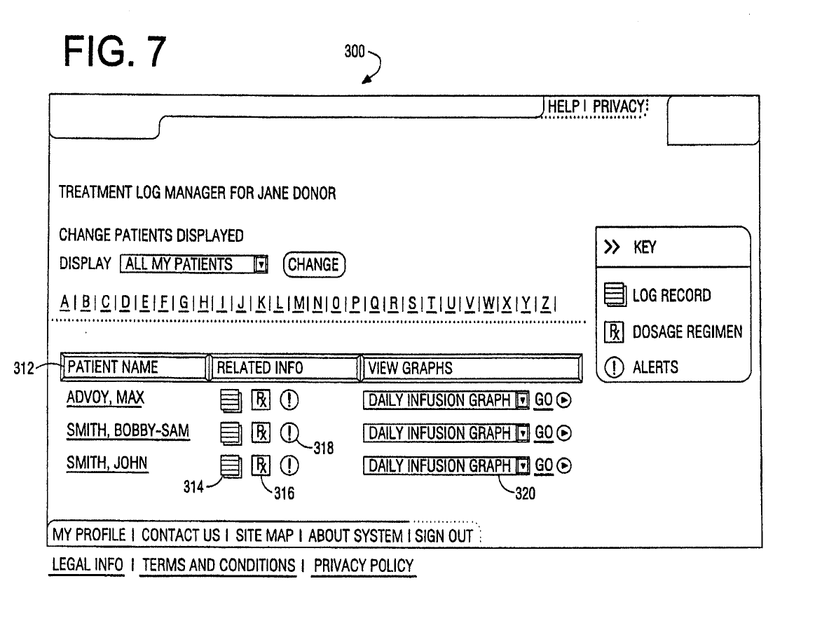

In one embodiment of the present invention, the computer program 1 is comprised of several databases, or data separations within a memory. For example, the computer program 1 may include a database for storing a plurality of patient identifiers. The databases may be stored separately, on a central server, or integrated into the computer program 1. Further, each database is viewable and selectable through an interface screen. Accordingly, in the preferred embodiment, the computer program includes a code segment for generating a selectable graphical user interface screen which displays a list of patients which may be included in the patient selection data. FIG. 6 illustrates an example of such a database as viewed via an interface screen 200.

According to the embodiment in FIG. 6, the interface screen 200 includes a first menu 210 containing a predetermined list of patient identifiers, i.e., patient names. The interface screen 200 also contains a second menu 212 for displaying selected patients that will trigger an alert if health data input by that patient satisfies a prescribed criteria condition. In one embodiment, the interface screen 200 also includes an “Add” icon 214 and a “Remove” icon 216. By highlighting and selecting one of the patient names in the first menu 210 and then depressing the “Add” icon 214, the selected patient name then appears in the second menu 212. By highlighting a name appearing in the second menu 212 and depressing the “Remove” icon 212, the patient name is deleted from the list in the second menu 212. The interface screen of the present invention should not, however, be limited to the image of FIG. 6. Instead, it should be understood that the interface screen may be configured in any way suitable for displaying a multitude of selectable patient identifiers.

In one embodiment, the computer program also has a databases for storing a plurality of predetermined patient criteria. This database can be accessed through a separate interface screen generated by a code segment of the program. The patient criteria may, for example, correspond to a time interval between submissions of health data, the severity of a health condition, or a combination of predetermined health data submissions. Alternatively, the patient criteria can be any other symptom or response to which the health provider wants to be alerted.

One embodiment of the computer program also includes a database which stores a plurality alert recipient identifiers in which each alert recipient identifiers corresponds to a predetermined alert recipient. For example, the alert recipient identifiers can be health provider names, or health care medical units or any other identifier suitable for identifying a health provider. As with the databases described above, in the preferred embodiment of the present invention, a code segment exists for generating an interface screen to view and select the desired alert recipients.

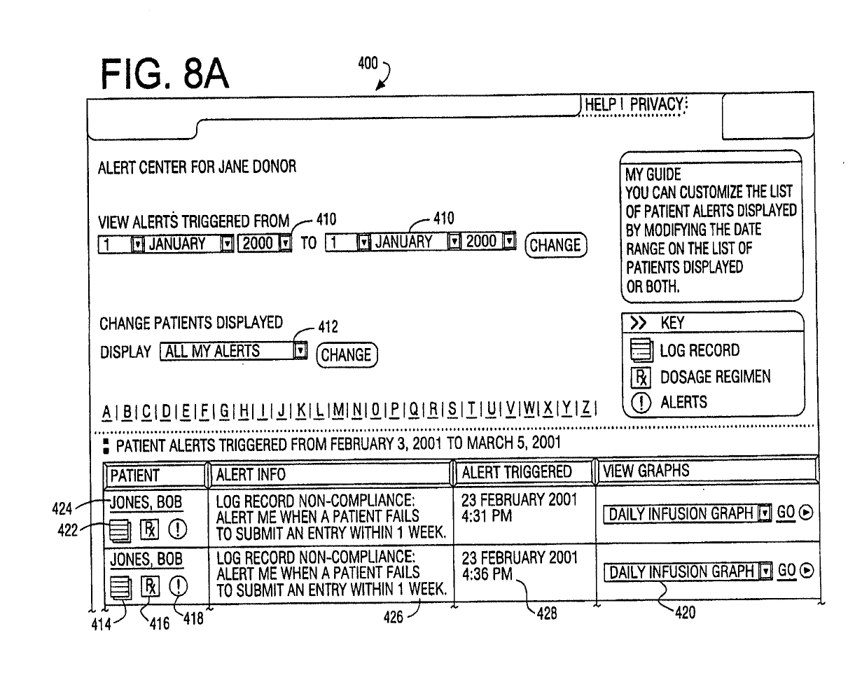

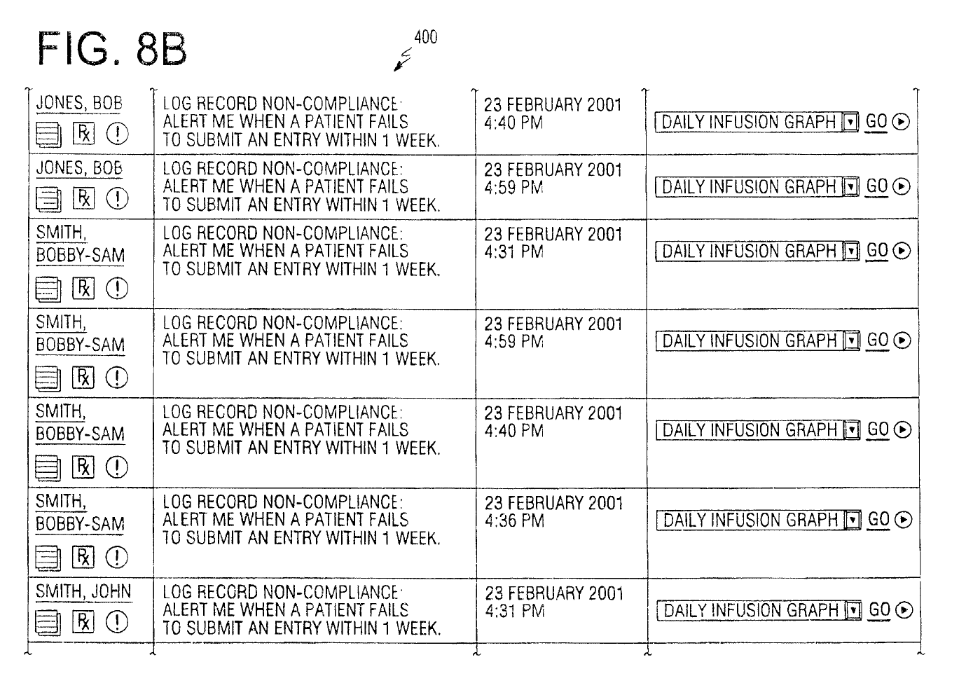

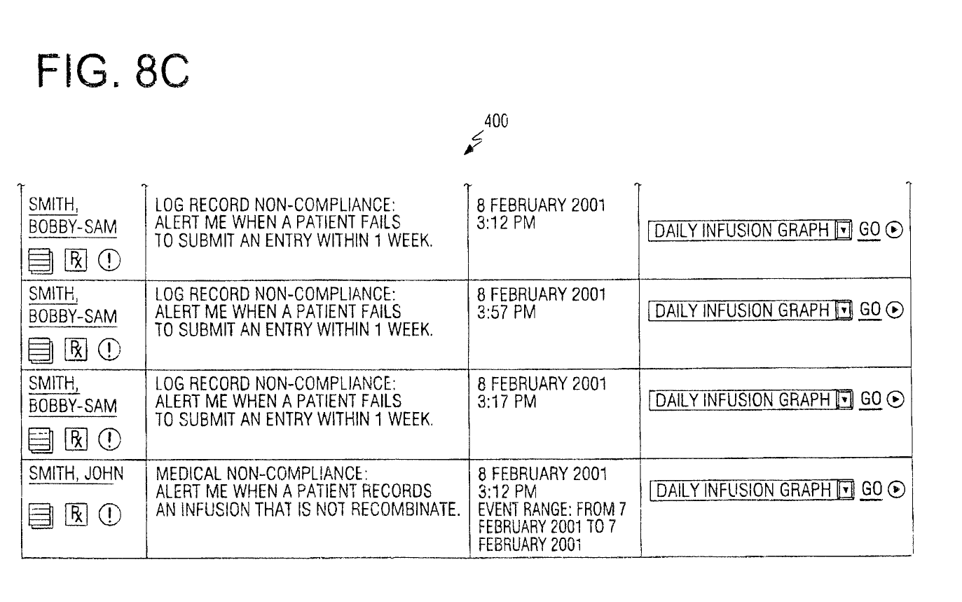

FIGS. 8A-8C illustrate an embodiment of an alert center display interface screen 400 which may be displayed on the health provider section 14. The alert center display interface screen 400 displays a log 422 of alerts that have been triggered over a selected time interval which is selectable in a drop down menu 410. The log 422 of the alert center display interface screen 400 is selectable to correspond with particular alert groups such that a health provider may monitor whether specific alert groups have triggered alerts over a predetermined time interval. In the embodiment shown in FIGS. 8A-8C, the log 422 displays the patient 424 that has triggered an alert, the alert criteria 426 which has caused the alert to be triggered, and the date and time 428 that the alert was triggered. The alert center display interface screen 400 shown in the embodiment of FIGS. 8A-8C also has includes a plurality of selectable buttons 414, 416, 418, that when depressed, cause the interface to display one of either a log record, dosage regimen or alert information. The log 422 includes a drop-down menu 412 of selectable options relating to the desired patient (or groups of patients) to be displayed in the log 422. The log 422 also includes a view graphs option, having a drop-down menu 420 of selectable options which allows a user to access graphical data relating to the treatment of a corresponding patient.

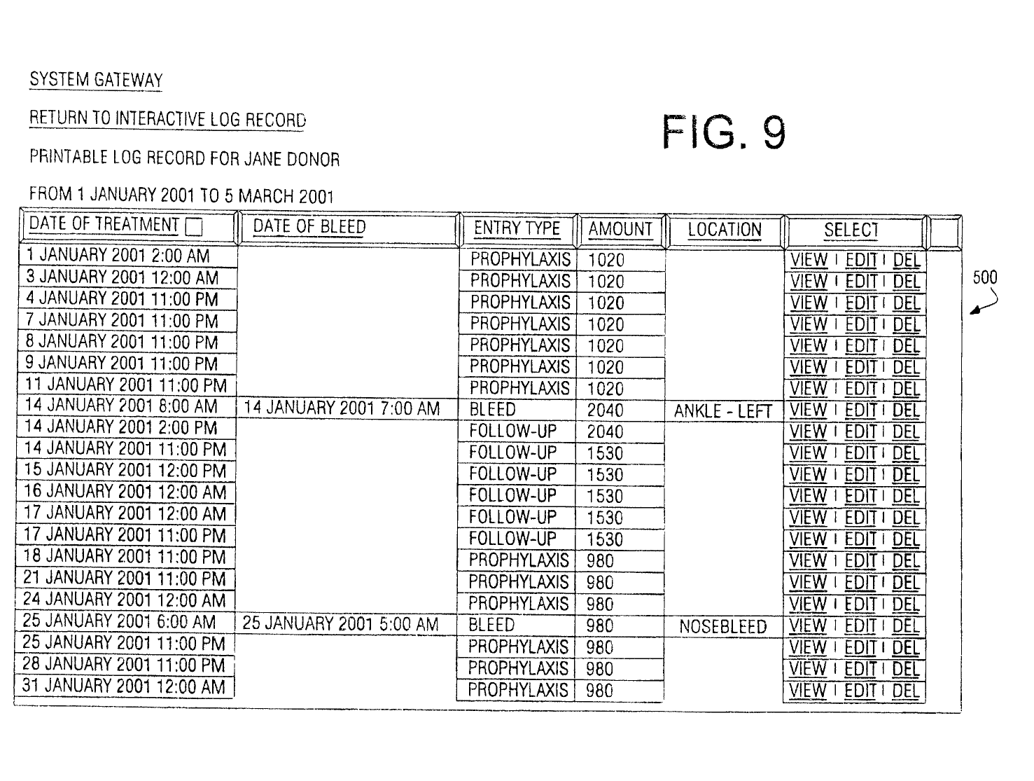

FIG. 9 depicts an embodiment of a patient log record 500 that may be displayed on either the of the health provider section 14 or the patient section 16. The log record 500 is stored in a memory and may be accessed, from the health provider section 14, by depressing a corresponding selectable icon 414 on the alert center display interface screen 400 or the treatment log manager interface screen 300. Similar selectable icons may be displayed on the interface screens in patient section 16. In one embodiment depicted in FIG. 9, the log record 500 displays relevant information about a therapy recommendation of a selected patient. However, it is contemplated that other information concerning patient treatment may also be displayed in the log record 500. It is also contemplated that the log record 500 may be printable or downloadable to a different storage media.

The computer program may also include a plurality of sub-databases. Each sub-database includes a plurality of predetermined alert recipients. Each user group is grouped according to predetermined characteristics. A code segment is configured to receive a transmission to include in an alert group, all alert recipients of at least one user group of alert recipients. In this way, an alert may be applied either individually or globally to an entire user group.

The present invention is capable of generating graphical representations and reports relevant data accumulated as a result of patient health data entry. Each of the graphs and reports appear as interface screens in either or both of the health provider and patient sections 14, 16, thereby providing a user with direct access relevant information. Each of the graphs generated by the present computer program derives the graphically represented data from one of a plurality of databases stored in a memory or directly from input from a client machine. It is contemplated that each of the databases may be responsive to SQL requests. Therefore, the data may be readily sorted into desired categories.

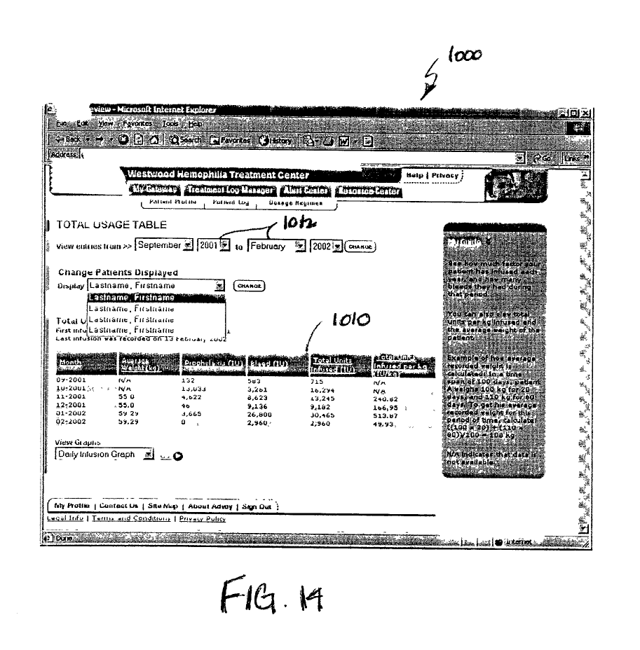

As illustrated in FIG. 13, the computer program 1 is adapted to provide an interface screen 900 depicting a graphical representation 910 of a patient's monthly usage. For example, the graph 910 of FIG. 13 illustrates prophylaxis and bleed infusions for a given patient over a six month period. The graph 910 includes a drop-down menu 920 which allows a user to chart represented data be over any time interval (e.g., hourly, weekly, monthly, annually) as the circumstances of treatment dictate. It is contemplated by the present invention that the desired time interval may be input by any suitable means, including key-stroke input fields or a selectable graphical representation, such as a calendar. The graph 910 of FIG. 13 also includes a graphical indicator 914 representative of a patient's expected usage volume based upon a given prescription. This graphical indicator 914 allows a health provider to monitor actual usage versus prescribed usage for a particular patient or group of patients. Accordingly, a user may monitor how close a patient has, come to complying with an ideal or prescribed treatment recommendation.

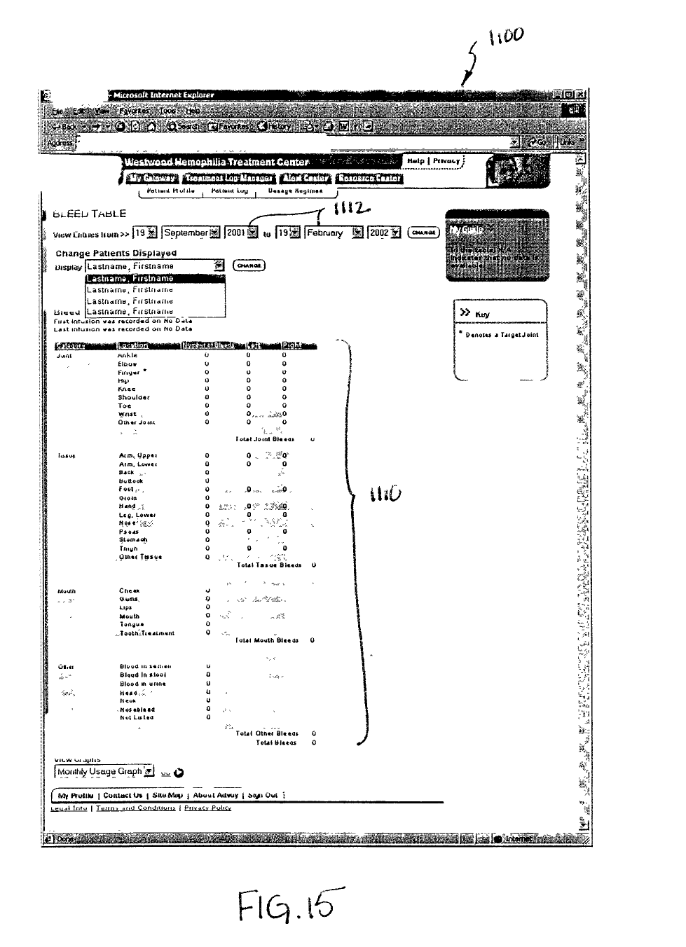

FIG. 14 illustrates an interface screen 1000 depicting of a report 1010 of a patients total usage. The report 1010 depicted in FIG. 14 allow a user to manage therapy recommendations by displaying data relating to a patient's total usage over a over a selected time interval.

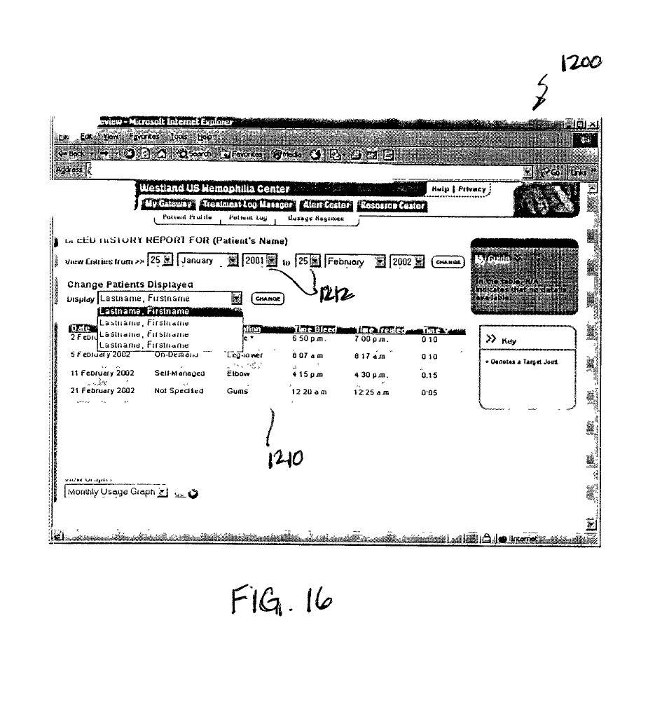

FIG. 15 illustrates another interface screen 1100 depicting a joint bleed report 1110 that may be generated by the present computer program. The relevant information depicted in the report 1100 of FIG. 15 may be reported over any prescribed time interval (e.g., hourly, weekly, monthly, annually) as the circumstances of treatment dictate. Again, while the embodiment shown uses a drop-down menu 1112, it is contemplated by the present invention that the desired time interval may be input by any suitable means, including key-stroke input fields or a selectable graphical representation, such as a calendar.

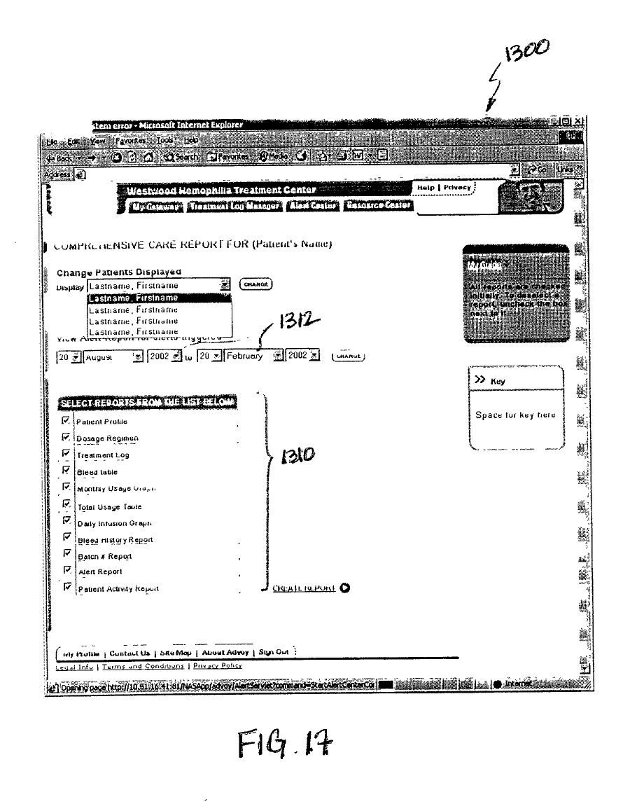

FIG. 16 illustrates an interface screen 1200 displaying a new bleed history report 1210. The report 1210 of FIG. 16 depicts a report regarding a bleed history of a particular patient over a selectable time interval. As with the reports described above, the relevant information depicted in the report 1210 may be reported over any prescribed time interval (e.g., hourly, weekly, monthly, annually) by selecting the time period from a drop-down menu 1212 or any other suitable means, including key-stroke input fields or a selectable graphical representation, such as a calendar (not shown).

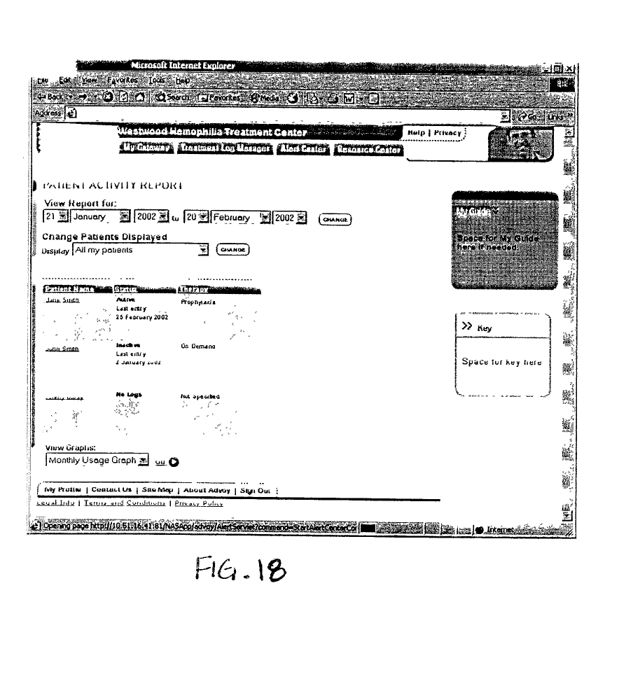

FIG. 17 illustrates another interface screen 1300 for generating a comprehensive care report (not shown). The report of FIG. 17 allows a user to select specific reports to be included in a comprehensive work. In the embodiment depicted in FIG. 17, a selectable click-chart 1310 is provided from which the desired reports to be included in a comprehensive report may be selected. It is contemplated, however, that the reports comprising the comprehensive report be selected by other means, such as a selectable graphical representation. The relevant information depicted in the table of FIG. 17 may be reported over any prescribed time interval (e.g., hourly, weekly, monthly, annually) as the circumstances of treatment dictate. Again, while the embodiment shown uses a drop-down menu 1312, it is contemplated by the present invention that the desired time interval may be input by any suitable means, including key-stroke input fields or a selectable graphical representation, such as a calendar.

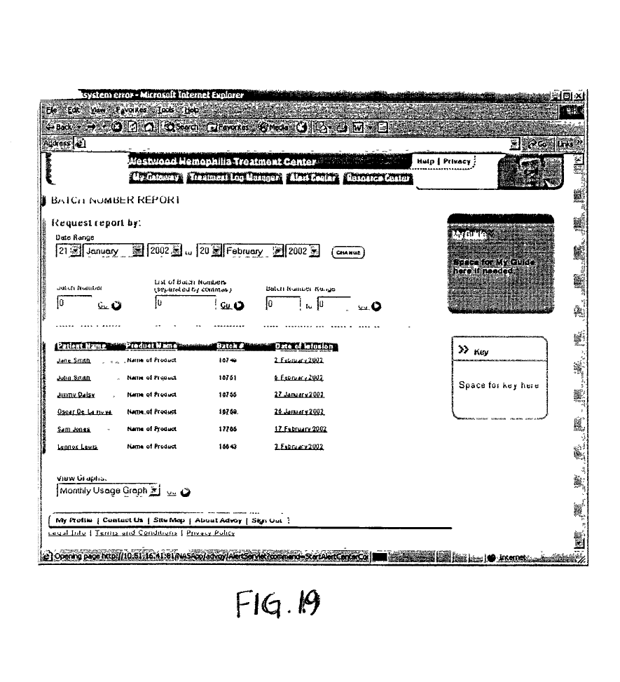

Other reports may be generated by the present invention, including a new patient activity report as depicted in FIG. 18 and a batching report a shown in FIG. 19. It is also contemplated that reports other than those described herein, but which assist a health provider in managing health data input by a patient (or care giver) and other relevant patient information, may be generated by the present software.

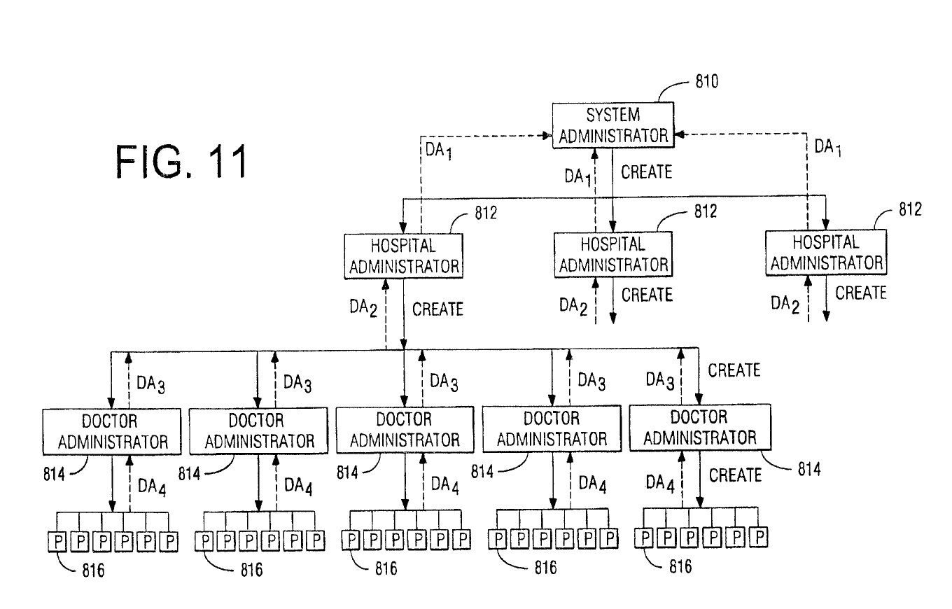

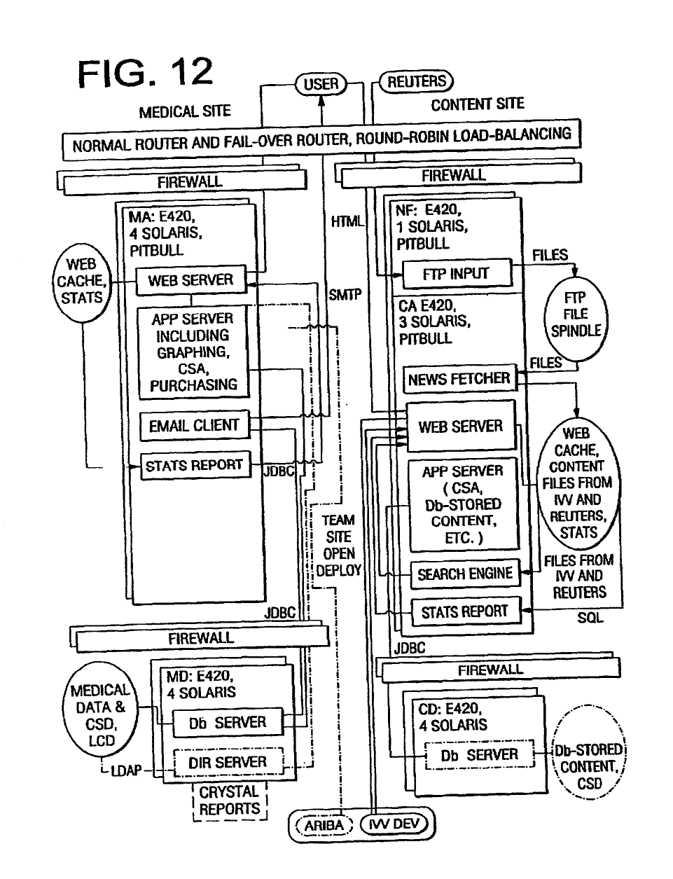

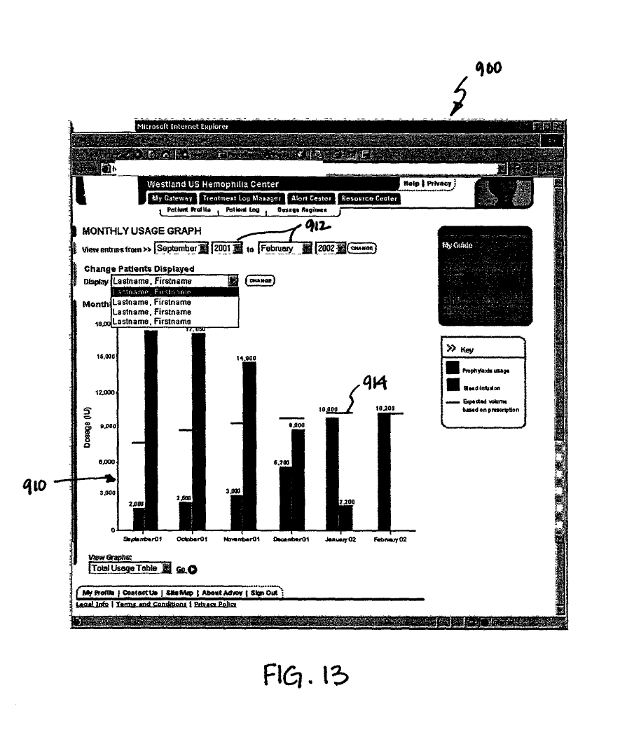

As illustrated in FIG. 11, administrators at various levels may create and manage user accounts. Administrators may also create and maintain accounts for other administrators. Thus, there are different classes of administrators, all organized in a hierarchy. For example, the highest-level system administrator 810 might create and manage a lower level account for the administrator of multiple hospitals 812. Each hospital administrator 812, in turn, might create and manage the administrator account for each doctor administrator 819 that practices in the hospital administrator's 814 hospital. The doctor administrator 814, in turn, might create and manage the account for each patient 816 in the care of the doctor.

As shown in FIG. 11, according to one embodiment of the present invention, an administrator at a higher lever can only create and manage an account for an administrator at the level immediately below that administrator. Thus, for example, the highest level system administrator 810 could only create and manage an account for a hospital administrator, not an account for a doctor administrator 814 or for a patient 816. Further, a junior administrator can have data access rights not possessed by the senior administrator that created the junior administrator's account. Thus, for example, the hospital administrator 812 might not be able to see patient data, while the doctor administrator 812, whose account was created by the hospital administrator 812, would be given this access.

Further, one class of user can set criteria for when a medical alert is sent to another class of user. For example, hospital administrator 812 can set the criteria for when an alert is delivered to an entire doctor administrator group 818. According to a preferred embodiment of the present invention, a single medical alert can be set to be delivered to entire classes of users, not just to a single user. For example, the report of a pre-determined number of patient bleeds could be set to cause an alert to be sent to a group of physicians.

In order to effectuate the hierarchal arrangement of user classes described above, the computer program for managing patient health data has a first code segment for defining a first user class. The first user class is assigned a plurality of first user class access rights. At least one of the assigned first user class access rights enables the first user class to create a user account for a second user group.

The program, therefore, include a second code segment for defining a second user class. Each member of the second user class is assigned an access identifier for the user account. The access identifier provides the second user class with a set of predetermined second user class access rights. In this way the first user class is restricted from accessing account data associated with the user account, including patient identifiers, patient criteria, criteria condition, and alert recipients.

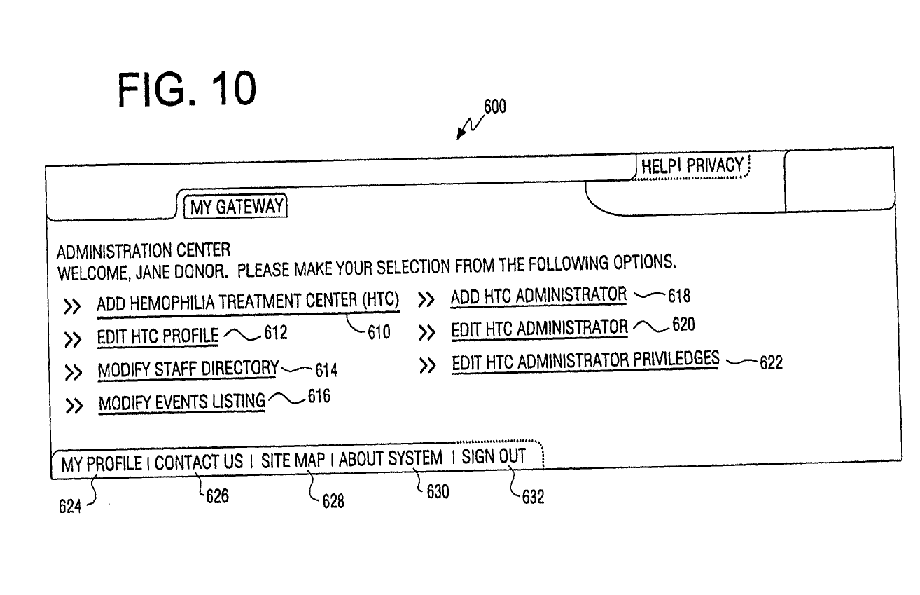

As described above, separate user classes may be established for patients, health providers and administrators. Each user class is provided with functions and data access rights that are different from the other user classes. FIG. 10 illustrates an embodiment of a welcome screen 600 which is displayed on the health provider interface which allows an administrator of a particular user class to manage the accounts described above. Specifically, as may be seen in FIG. 10, the welcome screen 600 provides a plurality of selectable administration prompts that allow an administrator to add to or edit user classes, profiles, events and directories. In the embodiment illustrated in FIG. 10, the plurality of selectable administration prompts include: an “Add Hemophilia Treatment Center” prompt 610, an “Edit HTC Profile” prompt 612, a “Modify Staff Directory” prompt 614, a “Modify Events Listing” prompt 616, an “Add HTC Administrator” prompt 618, an “Edit HTC Administrator” prompt 620, and an “Edit HTC Administrator Privileges” prompt 622. When any of the prompts 610, 612, 614, 618, 620, 622 are selected, a corresponding screen or entry prompt is displayed on the health provider interface 14. The entry prompt may be in the form of a text box, a drop-down menu, a graphical representation displaying corresponding information, or any other mechanism suitable for entry of information corresponding to the selected administration prompt.

The welcome screen can also include a plurality of selectable menu prompts that, when selected, cause a corresponding screen to be displayed on the health provider interface 14. For example, as seen in FIG. 10, the menu prompts may include: a “My Profile” prompt 624, a “Contact Us” prompt 626, A “Site Map” prompt 628, an “About System” prompt 630, and a “Sign Out” prompt 632.

All of the features of the invention that are discussed above could all be present in a single system. However, the invention also embraces systems and methods that implement only a subset of these features. Further, the features that have been discussed thus-far are merely illustrative of the invention, not exhaustive. For example, although having been discussed in the context of the Internet, it is to be understood that the invention is also applicable to other types of networked communication systems, such as local area networks (LAN), wide area networks (WAN) and telephones. Similarly, although the invention has been discussed in the context of chronic diseases, such as hemophilia, the invention also has application to numerous other areas of medical treatment, diagnosis and support.

Hence, it will be understood that the invention may be embodied in other specific forms without departing from the spirit or central characteristics thereof. The present embodiments, therefore, are to be considered in all respects as illustrative and not restrictive, and the invention is not to be limited to the details given herein.

What is claimed is:

1. A method for managing patient health data by communicating through a computer application, the method comprising the steps of:
providing a plurality of input fields for receiving input data, the input data comprising at least one patient identifier, at least one patient criteria, at least one criteria condition, and at least one alert recipient;
receiving a transmission of the at least one patient identifier;
receiving a transmission of the at least one patient criteria;
receiving a transmission of the at least one criteria condition corresponding to each of the at least one patient criteria;
receiving a transmission of the at least one alert recipient;
receiving a transmission of health data corresponding to the at least one patient criteria;
comparing the health data to the criteria condition; and,
transmitting an alert to the at least one alert recipient if the health data satisfies the criteria condition.

2. The method of claim 1, wherein the step of transmitting an alert comprises transmitting an electronic message to the at least one alert recipient.

3. The method of claim 1, wherein the step of transmitting an alert comprises transmitting an electronic mail message, wherein the electronic mail message does not include information regarding the health data.

4. The method of claim 1, wherein the patient criteria corresponds to a time interval between submissions of health data.

5. The method of claim 1, wherein the patient criteria corresponds to value relating to a quantified health condition parameter.

6. The method of claim 1, wherein the patient criteria corresponds to a combination of predetermined health data submissions.

7. The method of claim 1, further comprising the steps of providing a database, wherein the database comprises a plurality of patient identifiers; and, displaying the database through a selectable graphical representation.

8. The method of claim 1, further comprising the steps of providing a database, wherein the database comprises a plurality of predetermined patient criteria; and, displaying the database through a selectable graphical representation.

9. The method of claim 1, further comprising the steps of providing a database, wherein the database comprises a plurality of predetermined alert recipients; and, displaying the database through a selectable graphical representation.

10. The method of claim 9, wherein the database comprises a plurality of sub-databases, each sub-database comprising a plurality of predetermined alert recipients and defining a user group, each user group being grouped according to predetermined characteristics.

11. The method of claim 10, further comprising the step of selecting all of the alert recipients of at least one user group of alert recipients for receiving a global alert.

12. The method of claim 1, further comprising the step transmitting a therapy recommendation.

13. The method of claim 1, further comprising the step of displaying a historical health data log.

14. The method of claim 1, further comprising the step of displaying educational resources related to a relevant health condition.

15. The method of claim 1, further comprising the steps of:
transmitting a graphical representation of a human body for prompting an input transmission of health data corresponding to the at least one patient criteria, wherein the graphical representation has a sensing system for sensing a selected part of the image of the human body and transmitting health data corresponding to selected part of the image; and,
receiving an input transmission of health data transmitted by selecting a part of the image of the human body

16. The method of claim 1, wherein the transmitted health data is stored in a relational database responsive to SQL queries.

17. A computer program for managing patient health data, the computer program comprising:
a first code segment for receiving an input of patient selection data, said patient selection data defined by at least one of a plurality of patient identifiers;
a second code segment for receiving a transmission input of at least one patient criteria and at least one criteria condition corresponding to said patient criteria,
a third code segment for assigning the patient criteria and corresponding criteria condition to the at least one of the plurality of patients defined by the patient selection data;
a fourth code segment for receiving a transmission input of an alert group, said alert group being defined by at least one alert recipient;
a fifth code segment for receiving a transmission of health data from a client machine, wherein said health data corresponds to at least one of the patients defining the patient selection data and to the assigned patient criteria; and,
a sixth code segment for comparing transmitted health data to the criteria condition and to transmit a comparison result to a seventh code segment, the seventh code segment for receiving the comparison result from the sixth code segment and to transmit an alert to the alert group if the comparison result correlates to the criteria condition.

18. The computer program of claim 17, further comprising a database for storing a plurality of patient identifiers.

19. The computer program of claim 18, further comprising a code segment for displaying the database through a selectable graphical representation.

20. The computer program of claim 17, further comprising a database for storing a plurality of predetermined patient criteria.

21. The computer program of claim 20, further comprising a code segment for displaying the database through a selectable graphical representation.

22. The computer program of claim 17, wherein the patient criteria corresponds to a time interval between submissions of health data.

23. The computer program of claim 17, wherein the patient criteria corresponds to value relating to a quantified health condition parameter.

24. The computer program of claim 17, wherein the patient criteria corresponds to a combination of predetermined health data submissions.

25. The computer program of claim 17, further comprising a database for storing a plurality of alert recipient identifiers, the alert recipient identifiers corresponding to a plurality of alert recipients.

26. The computer program of claim 25, further comprising a code segment for displaying the database through a selectable graphical representation.

27. The computer program of claim 25, further comprising a plurality of sub-databases, wherein each sub-database includes a plurality of predetermined alert recipients and defines a user group, each user group being grouped according to predetermined characteristics.

28. The computer program of claim 27, further comprising a code segment for receiving a transmission to include in the alert group all alert recipients of at least one user group of alert recipients.

29. The computer of claim 17, further comprising a code segment for generating a graphical representation of a human body on a client machine display, wherein health data may be selected and transmitted through the graphical representation.

30. The computer program of claim 29, wherein the code segment further comprises a sensing system for sensing if a portion of the human body image is selected and transmits health data corresponding to a selected portion of the human body image.

31. The computer program of claim 17, further comprising a database for storing transmitted health data.

32. The computer program of claim 31, wherein the database for storing the health data is a relational database responsive to SQL queries.

33. The computer program of claim 17, further comprising a code segment for receiving and transmitting a therapy recommendation.

34. The computer program of claim 17, further comprising a code segment for generating a graphical user interface image of a historical health data log.

35. The computer program of claim 17, further comprising a code segment for receiving and transmitting educational resources related to a relevant health condition.

36. The computer program of claim 17, further comprising a code segment for generating a plurality of reports, wherein each of the reports comprises selectable criteria for customizing the report.

37. The computer program of claim 36, wherein the selectable criteria for customizing the report comprises at least one of a time interval, a patient identifier, and health data.

38. The computer program of claim 37, wherein the report comprises a monthly usage report, the monthly usage report comprising graphical representation of patient dosage for each month over a predetermined time period.

39. The computer program of claim 37, wherein the report comprises a bleed history report.

40. The computer program of claim 37, wherein the report comprises a total usage report.

41. The computer program of claim 37, wherein the report comprises a bleed table.

42. The computer program of claim 37, wherein the report comprises a total usage report.

43. The computer program of claim 37, wherein the report comprises a comprehensive care report, the comprehensive care report comprising a list of selectable sub-reports.

44. A method for managing patient health data associated with the treatment and therapy of patients having a chronic disease, the method comprising the steps of:
providing a system server;
providing a web interface being operably connected to the system server, the interface having a patient section and a health provider section, wherein the patient section is accessible upon entry of a first access identifier and the health provider section is accessible upon entry of a second access identifier;
providing a plurality of input fields for receiving input data from the, the input data fields being displayed in the patient section, the input data comprising at least one patient identifier, at least one patient criteria, at least one criteria condition, and at least one alert recipient;
providing a prompt in the health provider section prompting an input transmission of the at least one patient identifier;
providing a prompt in the health provider section prompting an input transmission of the at least one patient criteria;
providing a prompt in the health provider section prompting an input transmission of a criteria condition corresponding to each of the at least one patient criteria;
providing a prompt in the health provider section prompting an input transmission of the at least one alert recipient;
prompting the input of health data in the patient section;
receiving a transmission of health data corresponding to the at least one patient criteria;
comparing the health data to the criteria condition; and,
transmitting an alert to the at least one alert recipient if the health data satisfies the criteria condition.

45. The method of claim 44, further comprising the step of providing a communication conduit in the patient section to facilitate the interactive communication of client terminals having access to the server.

46. The method of claim 45, wherein the communication between the client terminals via the communication conduit occurs in real-time.

47. A computer program for managing patient health data, the computer program comprising:
a first code segment for defining a first user group, wherein the first user group is assigned a plurality of first user group access rights, and wherein at least one of the plurality of first user group access rights enables the first user group to create a user account for a second user group; and,
a second code segment for defining a second user group, wherein each member of the second user group is assigned an access identifier for the user account, wherein the access identifier provides the second user group with a plurality of second user group access rights and restricts the first user group from accessing account data associated with the user account, the account data comprising at least one of a patient identifier, patient criteria, criteria condition, and alert recipient.

48. The computer program of claim 47 further comprising a third code segment for receiving an input of patient selection data, said patient selection data being defined by at least one of a plurality of patients;
a fourth code segment for receiving a transmission input of at least one patient criteria and at least one criteria condition corresponding to said patient criteria,
a fifth code segment associated with the user account, the fifth code segment for assigning the patient criteria and corresponding criteria condition to the at least one of the plurality of patients defined by the patient selection data;
a sixth code segment associated with the user account, the sixth code segment for receiving a transmission input of an alert group, said alert group being defined by at least one alert recipient;
a seventh code segment associated with the user account, the seventh code segment for receiving a transmission of health data from a client machine, wherein said health data corresponds to at least one of the patients defining the patient selection data and to the assigned patient criteria; and,
an eighth code segment associated with the user account, the eighth code segment for comparing transmitted health data to the criteria condition and to transmit a comparison result to a ninth code segment, the ninth code segment for receiving the comparison result from the eighth code segment and to transmit an alert to the alert group if the comparison result correlates to the criteria condition.

49. The computer program of claim 48, wherein the alert comprises an electronic message.

50. The method of claim 49, wherein the alert comprises an electronic mail message, wherein the electronic mail message does not include information regarding the health data.

51. The computer program of claim 48, further comprising a database for storing a plurality of patient identifiers.

52. The computer program of claim 51, further comprising a code segment for displaying the database through a selectable graphical representation.

53. The computer program of claim 48, further comprising a database for storing a plurality of predetermined patient criteria.

54. The computer program of claim 53, further comprising a code segment for displaying the database through a selectable graphical representation.

55. The computer program of claim 48, where in the patient criteria corresponds to a time interval between submissions of health data.

56. The computer program of claim 48, wherein the patient criteria corresponds to value relating to a quantified health condition parameter.

57. The computer program of claim 48, wherein the patient criteria corresponds to a combination of predetermined health data submissions.

58. The computer program of claim 48, further comprising a database for storing a plurality of alert recipient identifiers, the alert recipient identifiers corresponding to a plurality of alert recipients.

59. The computer program of claim 58, further comprising a code segment for displaying the database through a selectable graphical representation.

60. The computer program of claim 48, further comprising a plurality of sub-databases, wherein each sub-database includes a plurality of predetermined alert recipients and defines a user group, each user group being grouped according to predetermined characteristics.

61. The computer program of claim 60, further comprising a code segment configured to receive a transmission to include in the alert group all alert recipients of at least one user group of alert recipients.

62. The computer of claim 48, further comprising a code segment for transmitting a graphical representation of a human body on a client machine display, wherein health data may be selected and transmitted through the graphical user interface image.

63. The computer of claim 62, wherein the code segment further includes a sensing system for sensing if a portion of the human body image is selected and transmits health data corresponding to a selected portion of the human body image.

64. The computer program of claim 48, further comprising a database for storing transmitted health data.

65. The computer program of claim 64, wherein database for storing the health data is a relational database responsive to SQL queries.

66. The computer program of claim 48, further comprising a code segment for receiving and transmitting a therapy recommendation.

67. The computer program of claim 48, further comprising a code segment for generating a graphical user interface image of a historical health data log.

68. The computer program of claim 48, further comprising a code segment for receiving and transmitting educational resources related to a relevant health condition.

69. A method for managing the administration of patient health data and therapy by communicating through a computer application, the method comprising the steps of:
defining a plurality of user classes comprised of a plurality of administrators, wherein the user classes are defined by a first level user class, as second level user class, a third user level class and a fourth level user class,
organizing the defined user classes into a hierarchy, the first level user class being the highest level user class in the hierarchy and the fourth level user class being the lowest level of the user classes in the hierarchy, wherein an administrator of a higher level can only create and manage an account for an administrator in the user class immediately below and wherein in the user class immediately below has data access rights not possessed by the administrator that created the account; and,
providing an interface for at least one of transmitting and receiving account data associated with the account, wherein the account data comprises at least one of a patient identifier, at least one patient criteria, at least one criteria condition, and an alert recipient.

70. The method of claim 69, further comprising the steps of:
receiving a transmission of the at least one user class identifier;
receiving a transmission of the at least one user class criteria;
receiving a transmission of at least one user class criteria condition for when a medical alert is sent to one of the plurality of user class;
receiving a transmission of data relating to the user class criteria condition, and,
transmitting an alert to the at least one alert recipient if the data relating to the user class criteria condition is satisfied.

71. A computer program for managing the administration of patient health data and therapy by communicating through a computer application, the computer program comprising:
a first code segment for receiving transmission input of a plurality of user classes comprised of a plurality of administrators, wherein the user classes are defined by a first level user class, as second level user class, a third user level class and a fourth level user class, wherein the defined user classes are organized in a hierarchy, the first level user class being the highest level user class and the fourth level user class being the lowest level of the user classes and wherein an administrator of a higher level can only create and manage an account for an administrator in the user class immediately below and wherein in the user class immediately below has data access rights not possessed by the administrator that created the account;
a second code segment for receiving transmission input of the at least one user class identifier;
a second code segment for receiving transmission input of the at least one user class criteria;
a third code segment for receiving transmission input of at least one user class criteria condition for when a medical alert is sent to one of the plurality of user class;
a fourth code segment for receiving transmission input of data relating to the user class criteria condition, and,
a fifth code segment for transmitting an alert to the at least one alert recipient if the data relating to the user class criteria condition is satisfied.
